(19) United States
(12) Patent Application Publication
(10) Pub. No.: US 2008/0211794 A1
(43) Pub. Date: Sep. 4, 2008

(54) Driving circuit, timing controller, and driving method for TFT LCD

(75) Inventors: Chien-Yu Yi, Hsin-Chu (TW); I-Shu Lee, Hsin-Chu (TW)

Correspondence Address: BACON & THOMAS, PLLC, 625 SLATERS LANE, FOURTH FLOOR, ALEXANDRIA, VA, 22314, US

(73) Assignee: AU Optronics Corp., Hsin-Chu (TW)

(21) Appl. No.: 12/068,477

(22) Filed: Feb. 7, 2008

(30) Foreign Application Priority Data
Mar. 2, 2007 (TW) 096107190

(51) Int. Cl. G06F 3/038

(52) U.S. Cl. 345/204

(57) ABSTRACT

A TFT LCD driving circuit, a timing controller and a method for reducing the power consumption thereof are disclosed, wherein the timing controller includes a video data determining circuit, and a power-saving source/gate timing control circuit. The video data determining circuit receives a video data and obtains an effective resolution parameter value from the video data. If the video data is not a full-frame video data and the effective resolution parameter vale of the video data is smaller than the resolution of the LCD panel, the video data determining circuit triggers the power-saving source/gate timing control circuit to control the operation of a plurality of gate driver ICs and a plurality of source driver ICs of the TFT LCD driving circuit, in order to reduce the number of the “turning-on” times of these gate driver ICs and source driver ICs.

### BACKGROUND OF THE INVENTION

1. Field of the Invention

The present invention relates to a thin film transistor liquid crystal display (TFT LCD), and more particularly, to a TFT LCD driving circuit, a timing controller and a driving method for a TFT LCD.

2. Description of Related Art

FIG. 1 is an illustration of an LCD panel for a conventional TFT LCD. If the full-frame resolution of the LCD panel 1 is 1024×768, and a video data is displayed on the LCD panel 1, the gate driver ICs (not shown) and the source driver ICs (not shown) configured on the LCD panel 1 have to be turned on for 768 times and 1024×3 (R, G, B) times, respectively. However, if the video data is not a full frame video data and the resolution of which is only 640×480, then the effective display area 10 of the LCD panel 1 will not correspond to the entire display area of the LCD panel 1, as shown in FIG. 1. Due to the limitations of the design of the conventional TFT LCD driving circuit, the source driver ICs and the gate driver ICs of the LCD panel 1 must respectively be turned on for 768 times and 1024×3 times to display the video data, regardless of the resolution of the video data being only 640×480. That is, in the non-effective display area 11 of the LCD panel 1, the corresponding source driver ICs and the gate driver ICs still remain their normal operation, even though their operation contribute nothing to the display of the video data. Thus, due to their useless operation, the power consumption of the driving circuit of the conventional TFT LCD display is high.

### SUMMARY OF THE INVENTION

An object of the present invention is to provide a TFT LCD driving circuit and a method for driving the TFT LCD, in order to effectively reduce the power consumption of the driving circuit.

Another object of the present invention is to provide a TFT LCD driving circuit and a method for driving the TFT LCD, in order to reduce the times of the clock/data outputting to the driving circuit.

According to a certain aspect, the present invention achieving these objects relates to a TFT LCD driving circuit for driving an LCD panel, which includes a plurality of data lines and a plurality of gate lines. The TFT LCD driving circuit comprises a plurality of source driver ICs, a plurality of gate driver ICs, and a timing controller. The source driver ICs are electrically connected to the LCD panel. The gate drivers ICs are electrically connected to the LCD panel, too. Besides, the timing controller is electrically connected to the source driver ICs and the gate driver ICs and further comprises a power-consumption-reducing source/gate timing control circuit and a video data determination circuit. The power-consumption-reducing source/gate timing control circuit adapts for controlling the source driver ICs and the gate driver ICs and drives the LCD panel with data writing times smaller than the number of the data lines of the LCD panel and/or with channels smaller than the number of the gate lines of the LCD panel. The video data determination circuit is electrically connected to the power-consumption-reducing source/gate timing control circuit, for receiving a video data, obtaining an effective resolution parameter value from the video data, and triggering the power-consumption-reducing source/gate timing control circuit into operation.

According to another aspect, the present invention which achieves these objects relates to a method for driving a TFT LCD. The method adapts for driving an LCD panel with a driving circuit, wherein the driving circuit comprises a plurality of source driver ICs and a plurality of gate driver ICs, and the LCD panel includes a plurality of data lines and a plurality of gate lines. The method comprises the steps: receiving a video data; analyzing the video data and determining a non-full frame resolution parameter of the video data; and providing a non-full frame driving control signal/data based on the non-full frame resolution parameter, adapting for controlling the source driver ICs and the gate driver ICs, in order to drive the LCD panel with data writing times smaller than the number of the data lines of the LCD panel and/or with channels smaller than the number of the gate lines of the LCD panel.

According to another aspect, the present invention which achieves these objects relates to a timing controller for use in a TFT LCD panel driving circuit which comprises a plurality of source driver ICs, and a plurality of gate driver ICs. The timing controller comprises a power-consumption-reducing source/gate timing control circuit and a video data determination circuit. The power-consumption-reducing source/gate timing control circuit is electrically connected to the source driver ICs and the gate driver ICs. The video data determination circuit is electrically connected to the power-consumption-reducing source/gate timing control circuit, for receiving a video data, obtaining an effective resolution parameter value from the video data, and triggering the power-consumption-reducing source/gate timing control circuit into operation.

According to another aspect, the present invention which achieves these objects relates to a timing controller for use in a driving circuit adapting for driving an LCD panel, wherein the driving circuit comprises a plurality of source driver ICs, and a plurality of gate driver ICs. The timing controller comprises a power-consumption-reducing source/gate timing control circuit and a video data determination circuit. The power-consumption-reducing source/gate timing control circuit adapts for controlling the source driver ICs and the gate driver ICs, in order to drive the LCD panel with data writing times smaller than the number of data lines of the LCD panel and/or with channels smaller than the number of gate lines of the LCD panel. The video data determination circuit is electrically connected to the power-consumption-reducing source/gate timing control circuit, for receiving a video data, obtaining an effective resolution parameter value from the video data, and triggering the power-consumption-reducing source/gate timing control circuit into operation based on the effective resolution parameter value.

The above-mentioned video data determination circuit determines whether the video data is full-frame video data, and obtains the effective resolution parameter value from analyzing if the video data is full-frame video data.

Also, the video data determination circuit determines whether the effective resolution parameter value of the video data is smaller than the resolution of the LCD panel. If the effective resolution parameter value of the video data is smaller than the resolution of the LCD panel, the video data determination circuit triggers the power-consumption-reducing source/gate timing control circuit into operation. That is, the video data determination circuit outputs the effective resolution parameter value to the power-consumption-reducing source/gate timing control circuit, which generates a non-full frame driving control signal/data and a data timing based on the effective resolution parameter value, in order to control the operation of the gate driver ICs and the source driver ICs.

The above-mentioned video data determination circuit triggers the power-consumption-reducing source/gate timing control circuit to control the gate driver ICs and the source driver ICs, so as to reduce the operating time of the gate driver ICs and the source driver ICs.

The timing controller further comprises a source/gate timing control circuit. When the video data is a full-frame video data, the video data determination circuit triggers the source/gate timing control circuit to control the source driver ICs and the gate driver ICs into operation.

The timing controller further comprises a low-frequency full-frame driver control circuit. The low-frequency full-frame driver control circuit comprises a polarity determination circuit, for determining the polarity of a non-full frame driving control signal/data provided by the power-consumption-reducing source/gate timing control circuit. Besides, the low-frequency full-frame driver control circuit is electrically connected to the video data determination circuit, the power-consumption-reducing source/gate timing control circuit, the source driver ICs, and the gate driver ICs.

As the video data determination circuit triggers the power-consumption-reducing source/gate timing control circuit, the low-frequency full-frame driver control circuit records the timing for a predetermined time period. After reaching the end of the predetermined time period, the low-frequency full-frame driver control circuit outputs a full-frame driving control signal/data to the source driver ICs and the gate driver ICs. Besides, the video data determination circuit triggers the power-consumption-reducing source/gate timing until the end of the predetermined time period.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic illustrating an LCD panel module of a conventional TFT LCD.

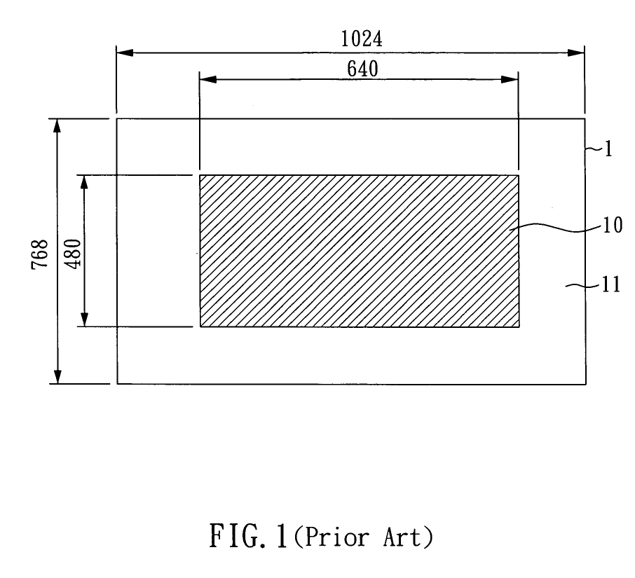

FIG. 2 is a functional block diagram of an LCD panel module according to an embodiment of the present invention.

FIG. 3 is a functional block diagram illustrating the interior working of a timing controller according to an embodiment of the present invention.

FIG. 4 is a flow diagram of an embodiment of the present invention.

FIG. 5 is a flow diagram illustrating a low-frequency full-frame driving scheme according to an embodiment of the present invention.

FIGS. 6A and 6B are the timing diagrams of the source driver ICs of the prior art illustrating the clock signals of the source driver IC.

FIGS. 7A and 7B are timing diagrams illustrating the clock signals of the source driver ICs according to an embodiment of the present invention.

FIG. 8 is a timing diagram illustrating the clock signals of the gate driver ICs of the prior art.

FIG. 9 is a timing diagram illustrating the clock signals of the gate driver ICs according to an embodiment of the present invention.

### DETAILED DESCRIPTION OF THE EMBODIMENT

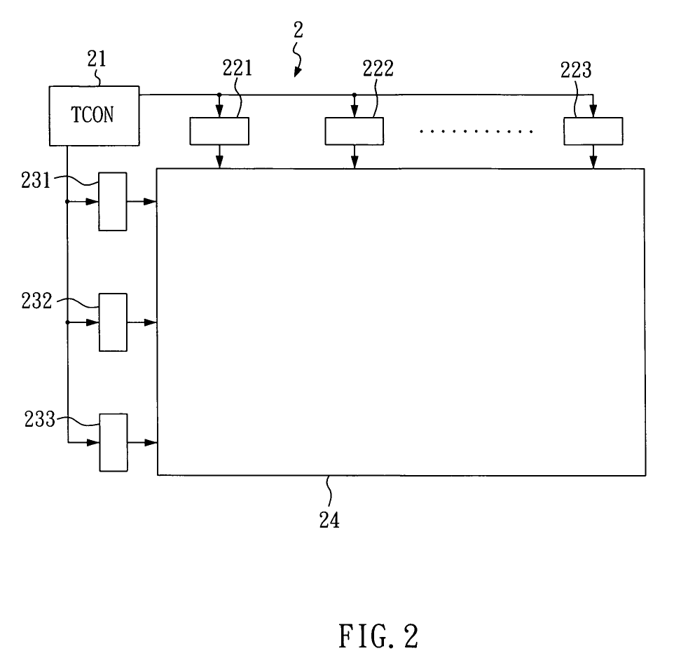

Reference should be made to FIGS. 2-5 for illustrating an embodiment of the present invention. FIG. 2 shows a functional block diagram of a panel module 2 according to an embodiment of the present invention. The panel module 2 comprises a timing controller (TCON) 21, a plurality of source driver ICs 221, 222, 223, a plurality of gate driver ICs 231, 232, 233, and an LCD panel 24.

The timing controller 21 is electrically connected to the source driver ICs 221, 222, 223 and the gate driver ICs 231, 232, 233, such that the timing controller 21 can control the operation of the source driver ICs 221, 222, 223 and the gate driver ICs 231, 232, 233. Besides, the source driver ICs 221, 222, 223 and the gate driver ICs 231, 232, 233 are all electrically connected to the LCD panel 24.

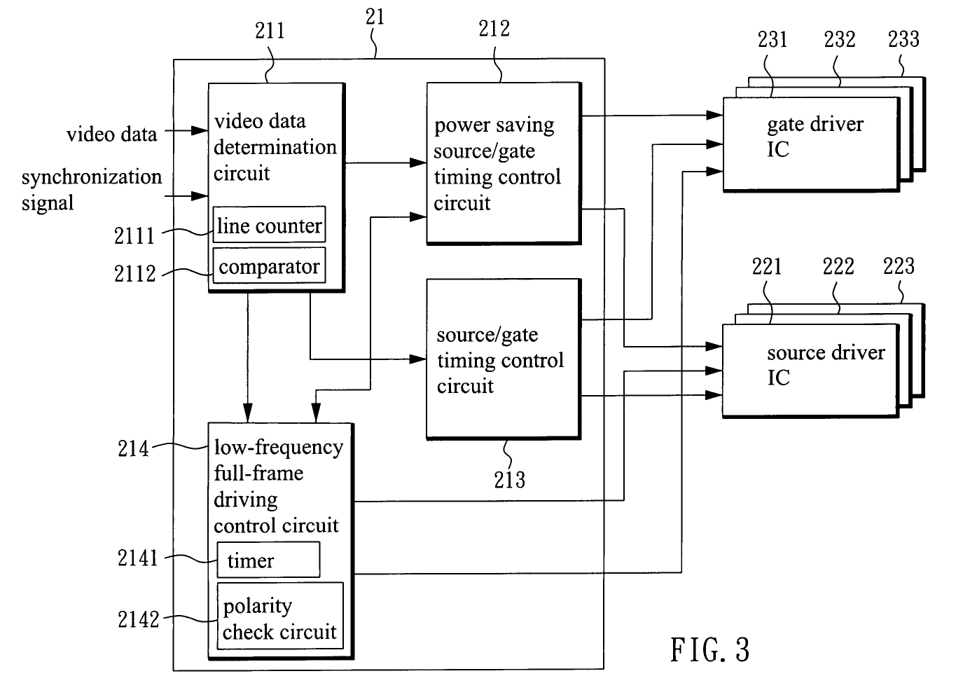

FIG. 3 is a functional block diagram of the timing controller 21, and as shown in the figure, the timing controller 21 comprises a video data determination circuit 211, a power-consumption-reducing source/gate timing control circuit 212, a source/gate timing control circuit 213, and a low-frequency full-frame driving control circuit 214. Preferably, the video data determination circuit 211 further comprises a line counter 2111 and a comparator 2112; and the low-frequency full-frame driving control circuit 214 further comprises a timer 2141 and a polarity determination circuit 2142.

The video data determination circuit 211 is electrically connected to the power-consumption-reducing source/gate timing control circuit 212, the source/gate timing control circuit 213, and the low-frequency full-frame driving control circuit 214. The power-consumption-reducing source/gate timing control circuit 212 is electrically connected to the gate driver ICs 231, 232, and 233 and the source driver ICs 221, 222, and 223, respectively. The source/gate timing control circuit 213 is electrically connected to the gate driver ICs 231, 232, 233 and the source driver ICs 221, 222, 223, respectively. The low-frequency full-frame driving circuit 214 is electrically connected to the power-consumption-reducing source/gate timing control circuit 212, the gate driver ICs 231, 232, 233, and the source driver ICs 221, 222, 223, respectively.

Moreover, the above-mentioned power-consumption-reducing source/gate timing control circuit 212 of the timing controller 21 adapts for controlling the operation of the gate driver ICs 231, 232, 233, and the source driver ICs 221, 222, 223, in order to drive the LCD panel 24 with data writing times smaller than the number of data lines of the LCD panel 24 and/or with channels smaller than the number of gate lines of the LCD panel 24. On the other hand, the video data determination circuit 211 receives a video data (not shown) and obtains an effective resolution parameter value from the video data. The video data determination circuit 211 then triggers the power-consumption-reducing source/gate timing control circuit 212 based on the effective resolution parameter value. The detail description of the driving method will be described hereinafter.

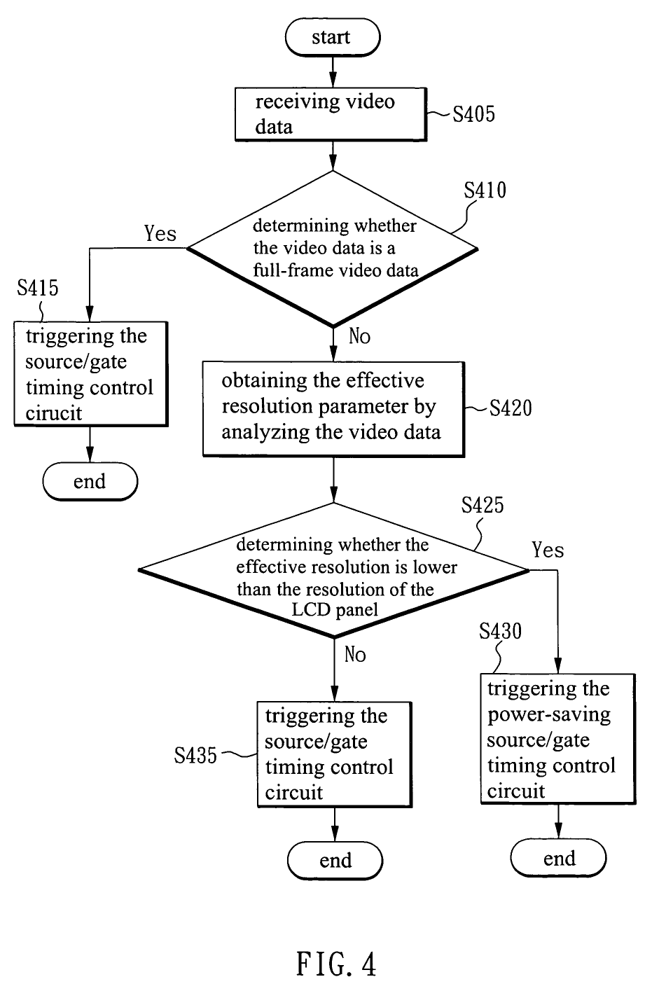

FIG. 4 is a flow diagram of an embodiment of the present invention, and the illustration of which should be made in reference together with FIGS. 2 and 3. First, the video data determination circuit 211 receives a video data and a synchronization signal from an external source (step S405). Then, the video data determination circuit 211 determines whether the video data is a full-frame video data (step S410).

In this embodiment, the video data determination circuit 211 performs point-by-point analysis of all the video data (R, G, B) on a data line within a data enable signal. If all the values of the video data on the data line within the data enable signal are all zeroes (i.e., the value of R, G B of each point are all 0), then the video data determination circuit 211 determines that the picture carried by the data enable signal is a black picture. Thus, the video data determination circuit 211 employs the above-described technique to determine the number of the black lines presenting in a video frame delivered by the video data (e.g. in a DVD picture, both the top portion and the bottom portion of the picture are black) and the location of these black lines. Also, through the same technique, the video data determination circuit 211 can determine the number of the effective data lines within a video frame in a Vsync signal.

If the video data is determined as a full-frame video data, the video data determination circuit 211 triggers the source/gate timing control circuit 213 to control the gate driver ICs 231, 232, 233 and the source driver ICs 221, 222, 223 into operation (step S415). On the other hand, if the video data is determined as a non-full frame video data, the video data determination circuit 211 obtains the effective resolution parameter values (e.g. the effective data columns/rows) by analyzing the video data (step S420). Besides, the video data determination circuit 211 continues performing the analysis on the video data until a predetermined value is satisfied, in order to verify whether the effective resolution parameter value of the video data is a fixed value.

For instance, the video data determination circuit 211 can perform point-by-point analysis of all the video data (R, G, B) on every data lines, in order to determine whether the data lines are effective data lines. If the video data on a data line is entirely black, then the data line is likely to contain ineffective video data. On the other hand, if the video data on a data line is not entirely black, then the data line is likely to contain effective data. Moreover, the video data determination circuit 211 can further record the number of the data lines containing ineffective data through a line counter 2111.

The above descriptions can be better understood through an example. In the case of a DVD film, the video data determination circuit 211 registers the number of the data lines containing ineffective data in the distinguishable black parts locating at the top section and the bottom section of a video frame of the DVD film through the line counter 2111. The video data determination circuit 211 then obtains the number of the data lines containing effective data through a comparator 2112. If the numbers of the data lines containing effective data in a series of successive video frames are the same, the video data determination circuit 211 can thus determine that the effective resolution parameter value of the DVD film is fixed. Preferably, the number of the video frames equals to the above-mentioned predetermined value.

Then, the video data determination circuit 211 determines whether the effective resolution parameter value of the video data is smaller than the resolution of the LCD panel 24 (step S425). If the effective resolution parameter value of the video data is indeed smaller than the resolution of the LCD panel 24, then the video data determination circuit 211 triggers the power-consumption-reducing source/gate timing control circuit 212 to control the gate driver ICs 231, 232, 233 and source driver ICs 221, 222, and 223, so as to reduce the turn-on times of the gate driver ICs 231, 232, 233 and the source driver ICs221, 222, and 223. In this manner, the power consumption of the driving circuit and the number of clock/data outputting to the driver circuit can be reduced (step S430).

For instance, when the effective resolution parameter value of the video data is smaller than the resolution of the LCD panel 24, the video data determination circuit 211 outputs the effective resolution parameter value to the power-consumption-reducing source/gate timing controller circuit 212, which generates a non-full frame driving control signal/data and a data timing based on the effective resolution parameter value. The gate driver ICs 231, 232, 233 and the source driver ICs 221, 222, 223 then operate based on the non-full frame driving control signal/data and the data timing.

If the effective resolution parameter value of the video data determination circuit 211 is 640×480, and the resolution of the LCD panel 24 is 1024×768, then the power-consumption-reducing source/gate timing control circuit 212 outputs N+480 gate control signals to the gate driver ICs 231, 232, 233, and outputs M×3+640×3 source controls signals. Preferably, N is the starting line count of the effective display area, and M is the starting point count of the effective display area. If the effective resolution of the video data is equal to the resolution of LCD panel 24, then video data determination circuit 211 triggers the source/gate timing control circuit 213 for controlling the gate driver ICs 231, 232, 233 and the source driver ICs 221 into operation (step S435).

The liquid crystal molecules of the LCD panel 24 may not withstand direct current bias for a long time, so after the video data determination circuit 211 triggering the power-consumption-reducing source/gate timing control circuit 212, the voltage applied to the liquid crystal molecules located in the non-effective display area of the LCD panel 24 have to be refreshed by applying a new voltage bias on the liquid crystal molecules, so as to prevent the deterioration of the liquid-crystal material.

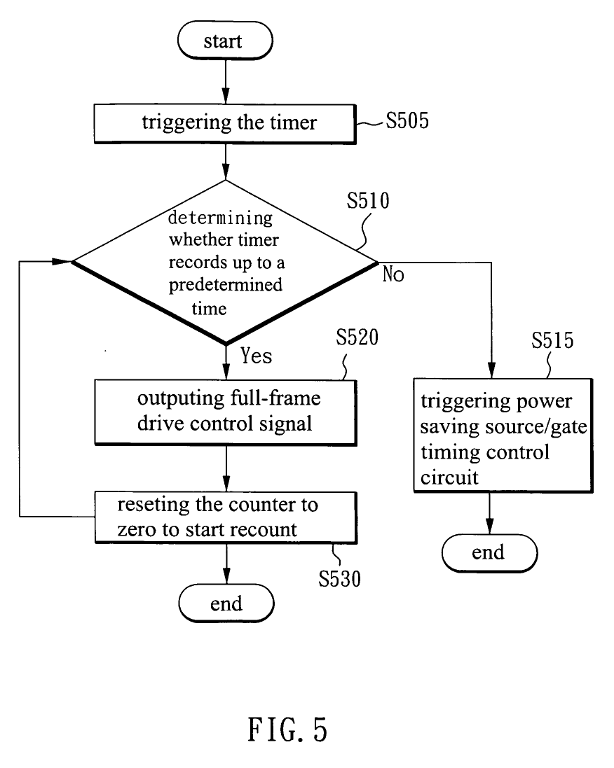

FIG. 5 shows a flow diagram illustrating a low-frequency full-frame driving scheme. Reference should also be made to FIGS. 2 and 3. After triggering the power-consumption-reducing source/gate timing control circuit 212, the video data determination circuit 211 controls the operation of the low-frequency full-frame driver control circuit 214. First, the timer 2141 of the low-frequency full-frame driver control circuit 214 starts to record a timing (step S505). Next, the low-frequency full-frame driver control circuit 214 determines whether the timing recorded by the timer 2141 has reached the end of a predetermined time period (step S510). If the timing has not reached the end of that the predetermined time period, the video data determination circuit 211 continues controlling the operation of the power-consumption-reducing source/gate timing control circuit 212 (step S515). But, once the timing recorded by the timer 2141 has reached the end of the predetermined time period, the low-frequency full-frame driver control circuit 214 starts outputting a full-frame driving control signal/data to the gate driver ICs 231, 232, 233 and the source driver ICs 221, 222 and 223, so as to execute the low frequency voltage renewal, in order to maintain the charging/discharging of the liquid crystal molecules (step S520).

Before outputting the full-frame driving control signal/data, the polarity determination circuit 2142 must first determine the polarity of the non-full-frame driving control signal/data provided by the power-consumption-reducing source/gate timing controller circuit 212. This is to prevent the problem of image flickering caused by sending the full-frame driving control signal/data with wrong polarity to the liquid crystal molecule, during the switching from the power-consumption-reducing source/gate timing control circuit 212 to the low-frequency full-frame driver control circuit 214. Thus, the polarity determination circuit 2142 of the low-frequency full-frame driver control circuit 214 is configured to determine the polarity of the non-full-frame driving control signal/data provided by the power-consumption-reducing source/gate timing control circuit 212, and then the low-frequency full-frame driver control circuit 214 further outputs the full-frame driving control signal/data to the gate driver ICs 231, 232, 233 and the source driver ICs 221, 222, 223.

After the low-frequency full-frame driver control circuit 214 outputs the full-frame driving control signal/data, the timer 2141 is reset to zero for recounting (step S530).

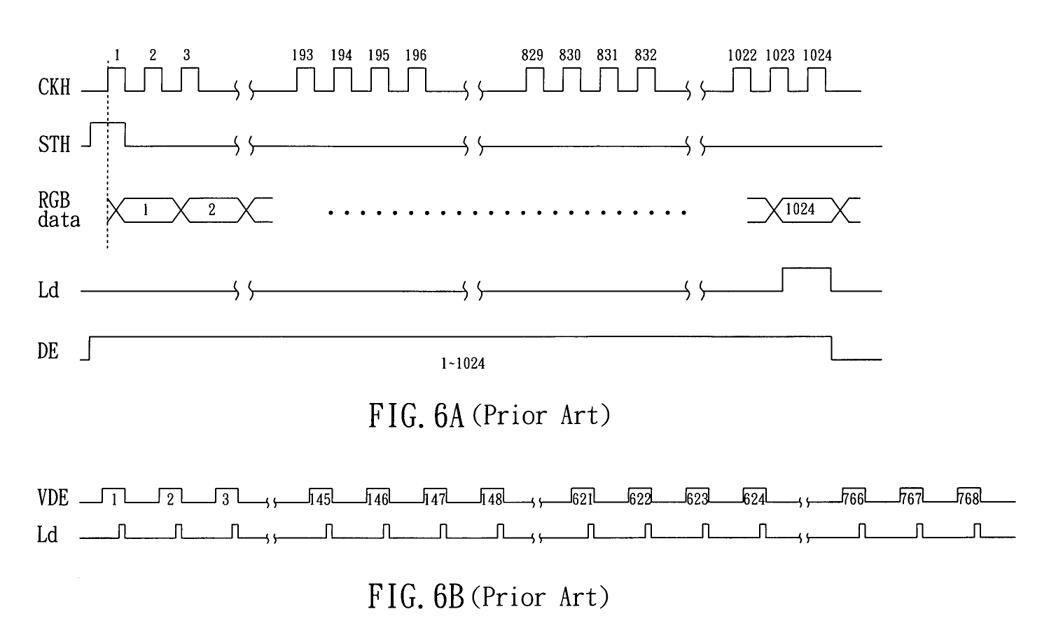

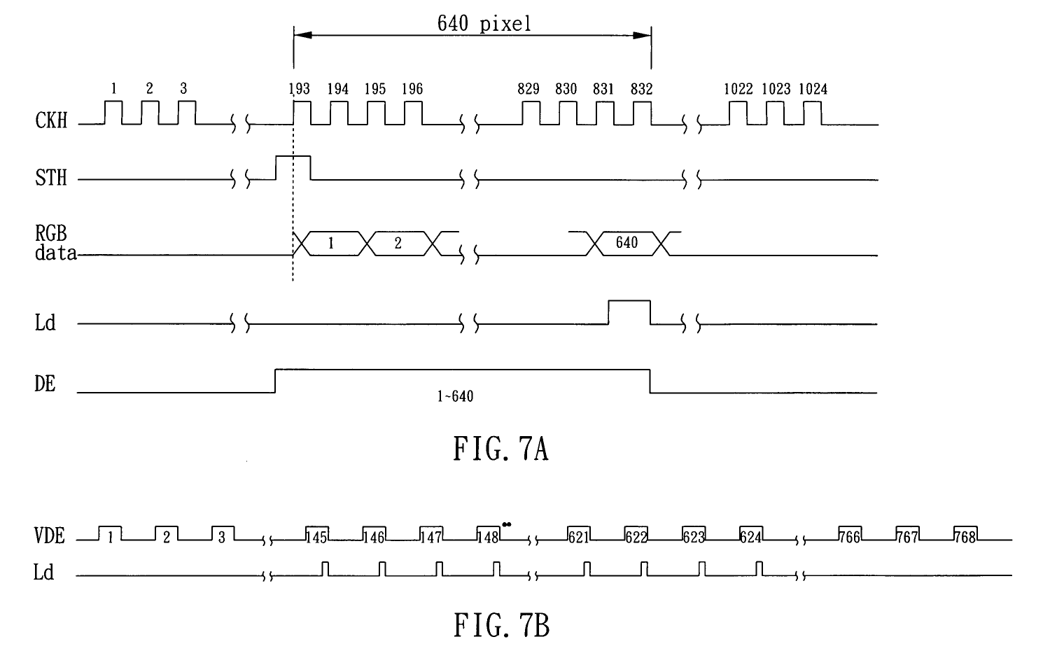

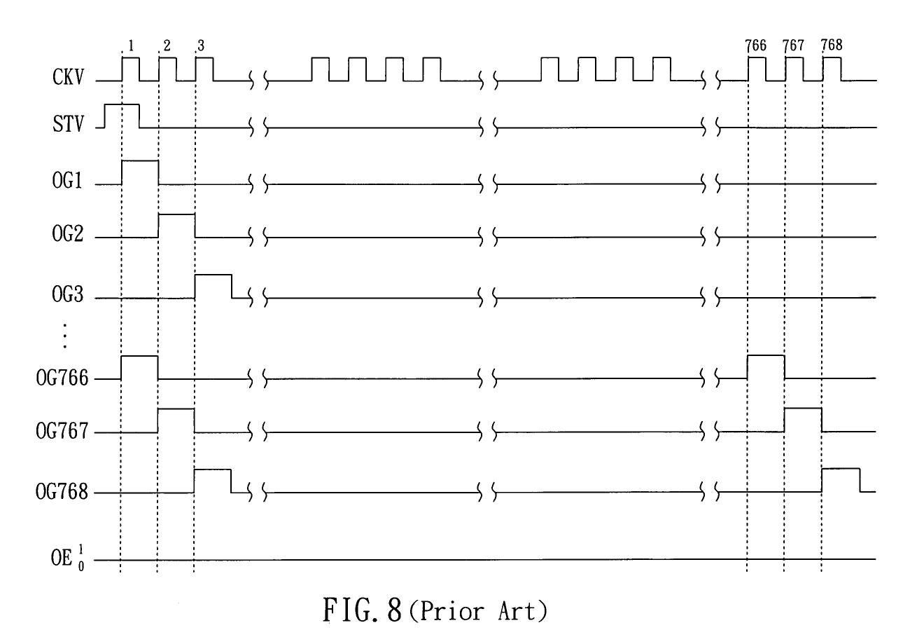

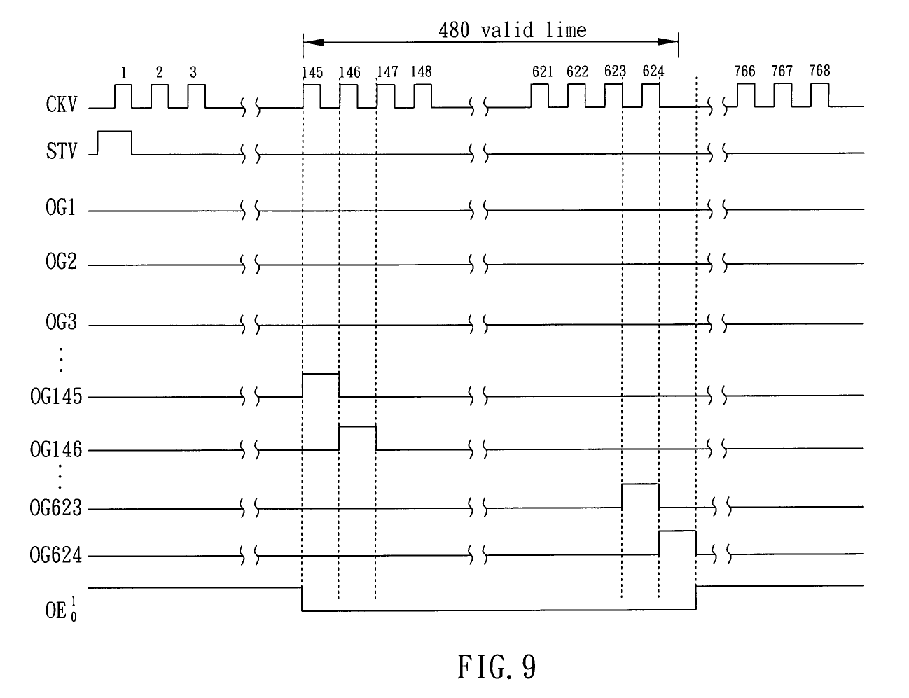

FIGS. 6A and 6B are timing diagrams of the source driver ICs of the prior art illustrating the clock signals of source driver ICs. FIGS. 7A and 7B are timing diagrams illustrating the clock signals of the source driver ICs of the present invention. FIG. 8 is a timing diagram illustrating the clock signals of the gate driver ICs of the prior art. FIG. 9 is a timing diagram illustrating the clock signals of the gate driver ICs of the present invention.

In FIG. 6A, if the resolution of the LCD panel is 1024×768, then regardless of the effective resolution parameter value of the video data, the initial clock pulse of the source driver ICs of the prior art is always outputted at the 1^{st} pixel of the LCD panel, wherein the last pixel of the LCD panel is the 1024^{th}. Besides, the source driver ICs of the prior art also start inputting the write-in data (R, G, B) at the 1^{st} pixel of the LCD panel, and output the write-in data at the 1024^{th} pixel of the LCD panel, so as to convert the write-in data into corresponding voltage biases. As a result, the write-in data outputting process should be repeated for 768 times, in order to cover the video data, as shown in FIG. 6B.

On the contrary, as shown in FIG. 7A, if the resolution of the LCD panel is 1024×768 and the effective resolution parameter value of the video data is 640×480, then the initial clock pulse of the source driver ICs provided by the present embodiment will not be outputted until the starting point (pixel) of the effective display area of the LCD panel (e.g. 193^{th} pixel) is reached. Also, the source driver ICs provided by the present embodiment will input the write-in data (R, G, B) at the 193^{th} pixel of the LCD panel and output the write-in data starting at the 832^{th} pixel of the LCD panel, for converting the write-in data into corresponding voltage biases. As shown in FIG. 7B, the write-in data only needs to be outputted for 480 times to effectively cover the video data. Hence, the number of the channels of the LCD panel that are driven by the source driver ICs of the present invention is smaller than 1024×3. That is, the source driver ICs of the prior art are required to drive 1024×3 channels of the LCD panel, whereas the source driver ICs of the present invention are only required to drive channels with a number smaller than 1024×3 of the LCD panel.

Similarly, as shown in FIG. 8, if the resolution of the LCD panel is 1024×768, then the gate driver ICs of the prior art always output gate clock signals from the first pixel line, with a total up to 768 gate clock signals, regardless of the effective resolution parameter value of the video data. That is, the gate driver ICs of the prior art require to be turned on for 768 times.

On the contrary, as shown in FIG. 9, if the resolution of the LCD panel is 1024×768, and the effective resolution parameter value of the video data is 640×480, then the state of the output enable signal provided by the gate driver ICs of the present invention is varied with the effective resolution parameter value of the video data. For instance, the output enable signal only needs to be set low from the 145^{th} pixel line to the 624^{th} pixel line of the LCD panel. That is, the gate driver ICs of the present invention only need to output gate control signals from the 145^{th} pixel line to the 624^{th} pixel line of the LCD panel. Hence, the number of the channels driven by the gate driver ICs is smaller than 768. Since the number of times that the gate/source driver ICs need to be turned-on is smaller than the number of times being turned-on by the gate/source driver ICs of the prior art, both the power consumption of the driver circuit, and the number of clock/data that need to be outputted to the driver circuit can be effectively reduced.

As described above, the timing controller of the present invention controls the gate driver ICs and the source driver ICs to output necessary control signals only within the effective display area of the LCD panel, rather than outputting controls signals aimlessly to cover the entire display area of the LCD panel, thereby, the power consumption of the driver circuit is greatly reduced.

Also, the timing controller of the present invention controls the gate driver ICs and the source driver ICs to output the necessary control signals only to the effective display area of the LCD panel, rather than outputting controls signals aimlessly to cover the entire display area of the LCD panel, thereby, the number of times that clock/data need to be output to the source driver ICs and the gate driver ICs is also greatly reduced.

Although the present invention has been explained in relation to its preferred embodiment, it is to be understood that many other possible modifications and variations can be made without departing from the spirit and scope of the present invention as hereinafter claimed.

What is claimed is:

1. A driving circuit for use in a thin film transistor liquid crystal display (TFT LCD), the TFT LCD having an LCD panel that includes a plurality of data lines and a plurality of gate lines, the driving circuit comprising:
a plurality of source driver integrated circuits (ICs) electrically connected to the LCD panel;
a plurality of gate driver ICs electrically connected to the LCD panel; and
a timing controller electrically connected to the source driver ICs and the gate driver ICs, wherein the timing controller comprises:
a power-consumption-reducing source/gate timing control circuit for controlling the source driver ICs and the gate driver ICs by driving the LCD panel with data writing times smaller than the number of the data lines of the LCD panel and/or with channels smaller than the number of the gate lines of the LCD panel; and
a video data determination circuit, electrically connected to the power-consumption-reducing source/gate timing control circuit, for receiving a video data, obtaining an effective resolution parameter value from the video data, and triggering the
power-consumption-reducing source/gate timing control circuit into operation.

2. The driving circuit of claim 1, wherein the video data determination circuit determines whether the video data is non-full-frame video data.

3. The driving circuit of claim 1, wherein the video data determination circuit determines whether the effective resolution parameter value of the video data is smaller than the resolution of the LCD panel.

4. The driving circuit of claim 1, wherein the video data determination circuit adapting for outputting the effective resolution parameter value to the power-consumption-reducing source/gate timing control circuit, which generates a corresponding control signal and a data timing based on the effective resolution parameter value, for controlling the operation of the gate driver ICs and the source driver ICs.

5. The driving circuit of claim 4, wherein the timing controller further comprises a low-frequency full-frame driver control circuit, the low-frequency full-frame driver control circuit including a polarity determination circuit, for determining the polarity of a non-full-frame driving control signal/data provided by the power-consumption-reducing source/gate timing control circuit.

6. The driving circuit of claim 5, wherein the timing controller further comprises a low-frequency full-frame driver control circuit, the low-frequency full-frame driver control circuit including a timer for recording the timing for a predetermined time period, after reaching the end of the predetermined time period, the low-frequency full-frame driver control circuit outputting a full-frame driver data to the source driver ICs and the gate driver ICs, for executing the low frequency voltage renewal, in order to maintain the charging/discharging of the liquid crystal molecules of the LCD panel.

7. The driving circuit of claim 1, wherein the video data determination circuit triggers the power-consumption-reducing source/gate timing control circuit to control the gate driver ICs and the source driver ICs so as to reduce the turn-on times of the gate driver ICs and the source driver ICs.

8. The driving circuit of claim 1, wherein the timing controller further comprises a source/gate timing control circuit, the video data determination circuit triggering the source/gate timing control circuit to control the source driver ICs and the gate driver ICs into operation, when the video data is full-frame video data.

9. The driving circuit of claim 1, wherein the timing controller further comprises a low-frequency full-frame driver control circuit, electrically connected to the video data determination circuit, the power-consumption-reducing source/gate timing control circuit, the source driver ICs, and the gate driver ICs.

10. The driving circuit of claim 1, wherein the timing controller further comprises a low-frequency full-frame driver control circuit, the low-frequency full-frame driver control circuit comprising a timer for recording the timing for a predetermined time period, the low-frequency full-frame driver control circuit outputting a full-frame driver data to the source driver ICs and the gate driver ICs until the end of the predetermined time period.

11. The driving circuit of claim 1, wherein the video data determination circuit includes a line counter for recording the number of ineffective lines of the video data determined by the video data determination circuit.

12. The driving circuit of claim 11, wherein the video data determination circuit includes comparator, the video data determination circuit recording the number of effective lines of an image of the video data by the comparator.

13. A method for driving a thin film transistor liquid crystal display (TFT LCD), adapted for driving an LCD panel with a driving circuit, wherein the driving circuit comprises a plurality of source driver integrated circuits (ICs) and a plurality of gate driver ICs, the LCD panel including a plurality of data lines and a plurality of gate lines, the method comprising the steps of:
receiving a video data;
analyzing the video data and determining a non-full frame resolution parameter of the video data; and
providing a non-full frame driving control signal/data based on the non-full frame resolution parameter, adapting for controlling the source driver ICs and the gate driver ICs, in order to drive the LCD panel with data writing times smaller than the number of the data lines of the LCD panel and/or with channels smaller than the number of the gate lines of the LCD panel.

14. The method of claim 13, wherein the method further comprises the steps of:
analyzing the video data and determining a full frame resolution parameter of the video data; and
providing a full frame driving control signal/data based on the full frame resolution parameter, adapting for controlling the source driver ICs and the gate driver ICs, in order to drive the LCD panel with the data writing times equal to the number of the data lines of the LCD panel or with the channels equal to the number of the gate lines of the LCD panel.

15. The method of claim 13, wherein, after controlling the source driver ICs and the gate driver ICs with the non-full frame driving control signal/data, the method further comprises the step of:
providing a full-frame driving control signal/data to the source driver ICs and the gate driver ICs, for controlling the source driver ICs and the gate driver ICs to execute the low frequency renewal, in order to maintain the charging/discharging of the liquid crystal molecules of the LCD panel.

16. The method of claim 15, the method further comprises the step of:
before providing the full-frame driving control signal/data to the source driver ICs and the gate driver ICs, selecting a polarity of the full-frame driving control signal/data for preventing the image flickering of the LCD panel.

17. The method of claim 13, wherein, during the step of controlling the source driver ICs and the gate driver ICs by applying the non-full frame driving control signal/data, a power-consumption-reducing source/gate timing control circuit is triggered and a low-frequency full-frame driver control circuit records the timing for a predetermined time period, after reaching the end of the predetermined time period, the low-frequency full-frame driver control circuit outputting a full-frame driving control signal/data to the source driver ICs and the gate driver ICs.

18. The method of claim 17, wherein, before reaching the end of the predetermined time period, a video data determination circuit triggers the power-consumption-reducing source/gate timing control circuit.

19. The method of claim 17, wherein the low-frequency full-frame driver control circuit further comprises a polarity determination circuit for determining a polarity of the full-frame driving control signal/data provided by the power-consumption-reducing source/gate timing control circuit.

20. The method of claim 13, wherein, during the step of controlling the source driver ICs and the gate driver ICs by applying the non-full frame driving control signal/data, a power-consumption-reducing source/gate timing control circuit generates the non-full frame driving control signal/data and a data timing based on the non-full frame resolution parameter, for controlling the source driver ICs and the gate driver ICs into operation.

21. The method of claim 13, wherein, if the video data is a full-frame video data, a source/gate timing control circuit is triggered for controlling the source driver ICs and the gate driver ICs, in order to drive the LCD panel with the data writing times equal to the number of the data lines of the LCD panel or with the channels equal to the number of the gate lines of the LCD panel.

22. A timing controller for use in a driving circuit for a thin film transistor liquid crystal display (TFT LCD) panel, comprising:
a power-consumption-reducing source/gate timing control circuit, electrically connected to a plurality of source driver integrated circuits (ICs) and a plurality of gate driver ICs; and
a video data determination circuit, electrically connected to the power-consumption-reducing source/gate timing control circuit, for receiving a video data, obtaining an effective resolution parameter value from the video data, and triggering the power-consumption-reducing source/gate timing control circuit into operation.

23. The timing controller of claim 22, wherein the video data determination circuit is adapted for determining the effective resolution parameter value of the video data, and if the effective resolution parameter value of the video data is smaller than a resolution of the LCD panel, smaller the video data determination circuit triggers the power-consumption-reducing source/gate timing control circuit into operation.

24. The timing controller of claim 22, wherein the video data determination circuit is adapted for outputting the effective resolution parameter value to the power-consumption-reducing source/gate timing control circuit, which generates a non-full frame driving control signal/data and a data timing based on the effective resolution parameter value, in order to control the operation of the gate driver ICs and the source driver ICs.

25. The timing controller of claim 22, wherein the video data determination circuit is adapted to trigger the power-consumption-reducing source/gate timing control circuit into operation, for controlling the gate driver ICs and the source driver ICs so as to reduce the turn-on times of the gate driver ICs and the source driver ICs.
